(19) United States
(12) Patent Application Publication
(10) Pub. No.: US 2022/0329698 A1
(43) Pub. Date: Oct. 13, 2022

(54) Support for Threshold as Well as Quota Based Usage-Monitoring for the Same Monitoring Key

(71) Applicant: Parallel Wireless, Inc., Nashua, NH (US)

(72) Inventors: Ganesh Jaju, Pune (IN); Ketan Parikh, Pune (IN)

(21) Appl. No.: 17/710,913

(22) Filed: Mar. 31, 2022

Related U.S. Application Data
(60) Provisional application No. 63/168,418, filed on Mar. 31, 2021.

(51) Int. Cl. H04M 15/00; H04L 12/14; H04L 41/0893; H04L 41/0894

(52) U.S. Cl. CPC H04M 15/66; H04M 15/58; H04L 12/1407; H04L 12/1435; H04L 41/0893; H04L 41/0894

(57) ABSTRACT

A method and computer readable media are disclosed to supply values for either/both of volume/time for usage-monitoring from/to PCRF for a particular usage monitoring key. In one embodiment, the method includes identifying a monitoring key AVP used by a PCRF to provide at least one of a volume usage threshold level for a Policy and Charging Enforcement Function (PCEF) and a time of usage threshold level for a PCEF; wherein the monitoring key includes at least one of a volume threshold total for the monitoring key; a volume quota uplink threshold for the monitoring key; a volume quota downlink threshold for the monitoring key; and a time threshold for the monitoring key; and supplying values for at least one of volume for usage-monitoring for a PCRF for a particular usage monitoring key; and time for usage-monitoring for a PCRF for a particular usage monitoring key.

### CROSS-REFERENCE TO RELATED APPLICATIONS

This application claims priority under 35 U.S.C. § 119(e) to U.S. Provisional Pat. App. No. 63/168,418, filed Mar. 31, 2021, titled “Support for Threshold as Well as Quota Based Usage-Monitoring for the Same Monitoring Key” which is hereby incorporated by reference in its entirety for all purposes. This application also hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety.

### BACKGROUND

The following documents describe existing Policy and Charging Control (PCC) specifications.

29.212-3rd Generation Partnership Project;

Technical Specification Group Core Network and Terminals;

Policy and Charging Control (PCC); Reference points

29.244-3rd Generation Partnership Project;

Technical Specification Group Core Network and Terminals;

Policy and Charging Control (PCC); Reference points

Spec 29.212 (Release f90)

5.3.60 Usage-Monitoring-Information AVP

The Usage-Monitoring-Information AVP (AVP code 1067) is of type Grouped, and it contains the usage monitoring control information.

The Monitoring-Key AVP identifies the usage monitoring control instance.

The Granted-Service-Unit AVP shall be used by the PCRF to provide the volume and/or the time of usage threshold level to the PCEF. The CC-Total-Octets AVP shall be used for providing threshold level for the total volume, or the CC-Input-Octets and/or CC-Output-Octets AVPs shall be used for providing threshold level for the uplink volume and/or the downlink volume. The CC-Time AVP shall be used for providing the time threshold to the PCEF. Monitoring-Time AVP shall be used for providing the time at which the PCEF shall reapply the threshold value provided by the PCRF.

The Used-Service-Unit AVP shall be used by the PCEF to provide the measured usage to the PCRF. Reporting shall be done, as requested by the PCRF, in CC-Total-Octets, CC-Input-Octets, CC-Output-Octets or CC-Time AVPs of Used-Service-Unit AVP. The Monitoring-Time AVP within the Used-Service-Unit AVP shall indicate the usage after the monitoring time as specified in clause 4.5.17.6.

The Quota-Consumption-Time AVP defines the time interval in seconds after which the time measurement shall stop for the Monitoring Key if no packets are received belonging to the corresponding Monitoring Key. The Quota-Consumption-Time may be included when the Usage-Monitoring-Information AVP also contains a Granted-Service-Unit including a CC-Time AVP (i.e. when the granted usage is for usage monitoring based on time). If the Quota-Consumption-Time AVP contains a value of zero, or if no Quota-Consumption-Time AVP is present, the time of usage shall be measured continuously from the point user plane traffic is detected for the corresponding Monitoring Key until the time usage measurement is disabled for the same Monitoring Key.

The Usage-Monitoring-Level AVP determines the scope of the usage monitoring instance.

The Usage-Monitoring-Report AVP determines if accumulated usage shall be reported for the usage monitoring key included in Monitoring-Key AVP.

The Usage-Monitoring-Support AVP determines if a usage monitoring instance is disabled.

AVP Format:

```
Usage-Monitoring-Information::= < AVP Header: 1067 >
    [ Monitoring-Key ]
  0*2 [ Granted-Service-Unit ]
  0*2 [ Used-Service-Unit ]
    [ Quota-Consumption-Time ]
    [ Usage-Monitoring-Level ]
    [ Usage-Monitoring-Report ]
    [ Usage-Monitoring-Support ]
    *[ AVP ]
```

Spec 29.244 (f40)

7.5.2.4 Create URR IE within PFCP Session Establishment Request

The Create URR grouped IE shall be encoded as shown in FIG. 7.5.2.4-1.

Table 7.5.2.4-1: Create URR IE within PFCP Session Establishment Request

| Octet 1 and 2 | Create URR IE Type = 6 (decimal) | | | | | | |
|---|---|---|---|---|---|---|---|
| Octets 3 and 4 | Length = n | | | | | | |
| | | | Appl. | | | | |
| Information elements | P | Condition/Comment | Sx a | Sx b | Sx c | N4 | IE Type |
| URR ID | M | This IE shall uniquely identify the URR among | X | X | X | X | URR ID |
| | | all the URRs configured for this PFCP session. | | | | | |
| Measurement | M | This IE shall indicate the method for measuring | X | X | X | X | Measurement |
| Method | | the network resources usage, i.e. whether the | | | | | Method |
| | | data volume, duration (i.e. time), combined | | | | | |
| | | volume/duration, or event shall be measured. | | | | | |
| Reporting | M | This IE shall indicate the trigger(s) for | X | X | X | X | Reporting |
| Triggers | | reporting network resources usage to the CP | | | | | Triggers |
| | | function, e.g. periodic reporting or reporting | | | | | |
| | | upon reaching a threshold, or envelope closure. | | | | | |
| Volume | C | This IE shall be present if volume-based | X | X | X | X | Volume |
| Threshold | | measurement is used and reporting is required | | | | | Threshold |
| | | upon reaching a volume threshold. When | | | | | |
| | | present, it shall indicate the traffic volume | | | | | |
| | | value after which the UP function shall report | | | | | |
| | | network resources usage to the CP function for | | | | | |
| | | this URR. | | | | | |
| Volume | C | This IE shall be present if volume-based | — | X | X | X | Volume |
| Quota | | measurement is used and the CP function needs | | | | | Quota |
| | | to provision a Volume Quota in the UP function | | | | | |
| | | (see subclause 5.2.2.2) | | | | | |
| | | When present, it shall indicate the Volume | | | | | |
| | | Quota value. | | | | | |
| Time | C | This IE shall be present if time-based | X | X | X | X | Time |
| Threshold | | measurement is used and reporting is required | | | | | Threshold |
| | | upon reaching a time threshold. When present, | | | | | |
| | | it shall indicate the time usage after which the | | | | | |
| | | UP function shall report network resources | | | | | |
| | | usage to the CP function for this URR. | | | | | |
| Time | C | This IE shall be present if time-based | — | X | X | X | Time |
| Quota | | measurement is used and the CP function needs | | | | | Quota |
| | | to provision a Time Quota in the UP function | | | | | |
| | | (see subclause 5.2.2.2) | | | | | |
| | | When present, it shall indicate the Time Quota | | | | | |
| | | value | | | | | |

### SUMMARY

A system and method is disclosed to identify a mechanism to be able to supply threshold and/or quota values for either/both of volume/time for usage-monitoring from/to PCRF for a particular usage monitoring key.

In one embodiment, a method for performing usage-monitoring for a same monitoring key is presented. The method may include identifying a monitoring key Attribute Value Pair (AVP) used by a Policy Charging Rules Function (PCRF) to provide at least one of a volume usage threshold level for a Policy and Charging Enforcement Function (PCEF) and a time of usage threshold level for a PCEF; wherein the monitoring key includes at least one of a volume threshold total for the monitoring key; a volume quota uplink threshold for the monitoring key; a volume quota downlink threshold for the monitoring key; and a time threshold for the monitoring key; and supplying at least one of threshold values and quota values for at least one of volume for usage-monitoring for a PCRF for a particular usage monitoring key; and time for usage-monitoring for a PCRF for a particular usage monitoring key.

In another embodiment a non-transitory computer-readable medium containing instructions for performing usage-monitoring for a same monitoring key, which, when executed, cause a system to perform steps including identifying a monitoring key Attribute Value Pair (AVP) used by a Policy Charging Rules Function (PCRF) to provide at least one of a volume usage threshold level for a Policy and Charging Enforcement Function (PCEF) and a time of usage threshold level for a PCEF; wherein the monitoring key includes at least one of a volume threshold total for the monitoring key; a volume quota uplink threshold for the monitoring key; a volume quota downlink threshold for the monitoring key; and a time threshold for the monitoring key; and supplying at least one of threshold values and quota values for at least one of volume for usage-monitoring for a PCRF for a particular usage monitoring key; and time for usage-monitoring for a PCRF for a particular usage monitoring key.

### BRIEF DESCRIPTION OF THE DRAWINGS

FIG. 1 is a diagram of a Granted-Service-Unit AVP, in accordance with some embodiments.

FIG. 2 is a diagram of a Used-Service-Unit AVP, in accordance with some embodiments.

FIG. 3 is a flow diagram of a method for performing usage-monitoring for a same monitoring key, in accordance with some embodiments.

FIG. 4 is a schematic network architecture diagram for 3G and other-G prior art networks.

FIG. 5 is an enhanced eNodeB for performing the methods described herein, in accordance with some embodiments.

FIG. 6 is a coordinating server for providing services and performing methods as described herein, in accordance with some embodiments.

### DETAILED DESCRIPTION

Current specifications 29.244 for Control Plane (CP) to User Plane (UP) communications provide CP with measures to configure either or both of quota/threshold for volume/time for a particular Usage Reporting Rule (URR).

But the current specifications 29.212 for PCRF do not empower it to supply both threshold as well as quota values at the same time for a particular usage monitoring key for either/both of volume/time. Before 29.244 (Control and User Plane Separation), the values supplied by PCRF were always assumed to be of type quota. The values received from PCRF are assumed to be of type quota by PCEF and it enforces them accordingly. So, operators are not able to fully utilize the benefits of the threshold method unless there is a local configuration to control this. However, with local configuration, PCRF will not have any control over it and hence cannot utilize it to its full potential.

Problems created by just having quota are:

With quota method, PCRF comes to know of usage-monitoring based usage only on quota expiry. When the quota is expired, the data traffic can be stopped by UP or limited preconfigured traffic can be allowed. So, this can lead to a loss of service or limited service for the user data traffic suddenly.

Another problem is that anytime PCRF wants to know the current usage, it must explicitly query the usage monitoring keys to find out the usage so that it can alert the user for usage or other offers. It might have to do that periodically or based on some events to take that decision.

The solution to above problems is extending the “Usage-Monitoring-Information” AVP's “Granted-Service-Unit” as well as “User-Service-Unit” AVPs to accommodate two types of values as follows:

| | |
|---|---|
| CC-Total-Octets | Existing volume quota total for |
| | that monitoring key. |
| CC-Input-Octets | Existing volume quota uplink for |
| | that monitoring key. |
| CC-Output-Octets | Existing volume quota downlink |
| | for that monitoring key. |
| CC-Time | Existing time quota for that |
| | monitoring key. |
| CC-Total-Threshold-Octets | Proposed volume threshold total |
| | for that monitoring key. |
| CC-Input-Threshold-Octets | Proposed volume quota uplink |
| | threshold for that monitoring key. |
| CC-Output-Threshold-Octets | Proposed volume quota downlink |
| | threshold for that monitoring key. |
| CC-Threshold-Time | Proposed time threshold for that |
| | monitoring key. |

The above additions solve the listed problems in following manner

If PCRF configures the threshold values, it will get periodic updates whenever that threshold is reached. The threshold is renewed on reporting without stopping data or allowing only limited data. So, the user experience is not hampered.

PCRF cannot know data usage pattern and so might query at adhoc times. So, it is possible that PCRF might not be able to utilize the queried information to decide when to query next. But having threshold provides UP a granular control so that it can supply PCRF (via CP) the reports at specified volume/time based threshold that PCRF can utilize to take relevant actions for configuring data threshold/quota.

With the proposed solution, PCRF can decide to configure based on its needs either only threshold, only quota or both. Upon reaching quota, the data traffic can be dropped or limited preconfigured traffic can be allowed.

### Example

Assume that for a monitoring key “K”, the PCRF configures a volume quota of 1 GB and volume threshold of 90 MB.

Then in such a case, PCEF will generate first report to PCRF at 90 MB usage and renew the threshold back to 90 MB.

The next usage report will be done when this threshold of 90 MB is hit which means a total of 180 MB data usage done.

The above process will continue till 990 MB when the 11th threshold hit report will be sent to the PCRF. So, here PCRF will information to conclude that only 10 MB of data is left with the user and can take relevant action based on the policy.

In case, no new quota is provided by the PCRF, existing quota will hit at 1 GB and data will be either silently dropped or limited preconfigured traffic will be allowed.

As can be seen in above example, PCRF is getting reports without querying periodically and can take informed decision for the user before quota expiry.

Existing AVP for Granted-Service-Unit

The Granted-Service-Unit AVP is currently defined as follows:

```
Granted-Service-Unit ::= < AVP Header: 431 >
  [ Tariff-Time-Change ]
  [ CC-Time ]
  [ CC-Money ]
  [ CC-Total-Octets ]
  [ CC-Input-Octets ]
  [ CC-Output-Octets ]
  [ CC-Service-Specific-Units ]
  *[ AVP ]
```

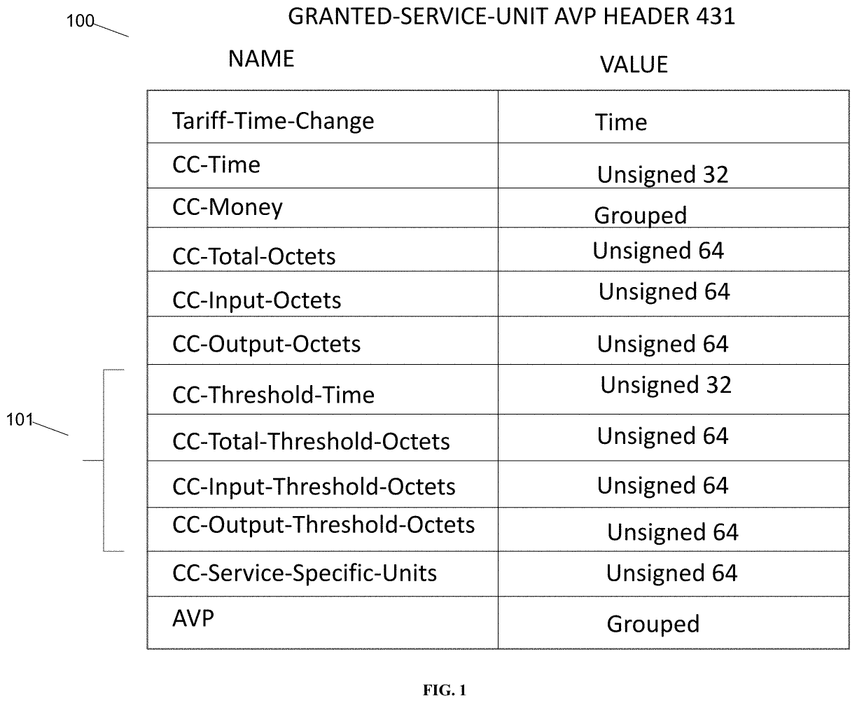

Proposed changes to Granted-Service-Unit AVP are highlighted below and in the diagram 100 in FIG. 1. The new elements are 101

```
Granted-Service-Unit ::= < AVP Header: 431 >
  [ Tariff-Time-Change ]
  [ CC-Time ]
  [ CC-Money ]
  [ CC-Total-Octets ]
  [ CC-Input-Octets ]
  [ CC-Output-Octets ]
  [ CC-Threshold-Time ]
  [ CC-Total-Threshold-Octets ]
  [ CC-Input-Threshold-Octets ]
  [ CC-Output-Threshold-Octets ]
  [ CC-Service-Specific-Units ]
  *[ AVP ]
```

The Used-Service-Unit AVP is currently defined as follows:

```
Used-Service-Unit ::= < AVP Header: 446 >
  [ Tariff-Change-Usage ]
  [ CC-Time ]
  [ CC-Money ]
  [ CC-Total-Octets ]
  [ CC-Input-Octets ]
  [ CC-Output-Octets ]
  [ CC-Service-Specific-Units ]
  *[ AVP ]
```

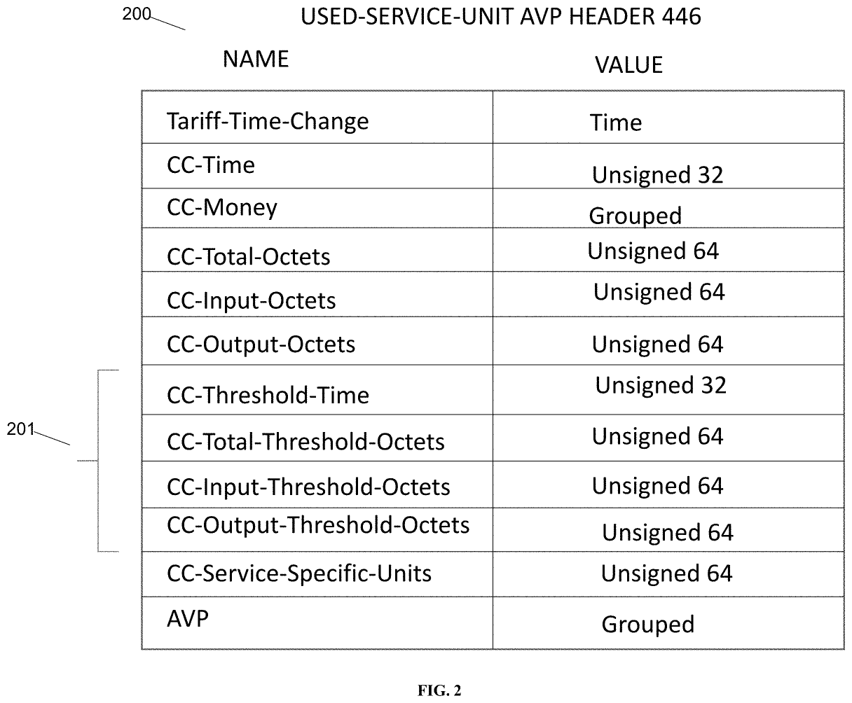

Proposed changes to Used-Service-Unit AVP are highlighted below are highlighted below and in the table 200 in FIG. 2. The new elements are 201:

```
  Used-Service-Unit ::= < AVP Header: 446 >
        [ Tariff-Change-Usage ]
[ CC-Time ]
    [ CC-Money ]
    [ CC-Total-Octets ]
        [ CC-Input-Octets ]
      [ CC-Output-Octets ]
      [ CC-Threshold-Time ]
        [ CC-Total-Threshold-Octets ]
      [ CC-Input-Threshold-Octets ]
      [ CC-Output-Threshold-Octets ]
      [ CC-Service-Specific-Units ]
      *[ AVP ]
```

| AVP Name | Description |
|---|---|
| CC-Threshold-Time | The CC-Threshold-Time AVP (AVP Code |
| | XXX) is of type Unsigned32 and indicates |
| | the length of the requested, granted, |
| | or used time in seconds for threshold. |
| CC-Total-Threshold-Octets | The CC-Total-Octets AVP (AVP Code |
| | XXX) is of type Unsigned64 and contains |
| | the total number of requested, granted, or |
| | used octets regardless of the direction |
| | (sent or received) for threshold. |
| CC-Input-Threshold-Octets | The CC-Input-Octets AVP (AVP Code |
| | XXX) is of type Unsigned64 and contains |
| | the number of requested, granted, or used |
| | octets that can be/have been received |
| | from the end user for threshold. |
| CC-Output-Threshold-Octets | The CC-Output-Octets AVP (AVP Code |
| | XXX) is of type Unsigned64 and contains |
| | the number of requested, granted, or used |
| | octets that can be/have been sent to the |
| | end user for threshold. |

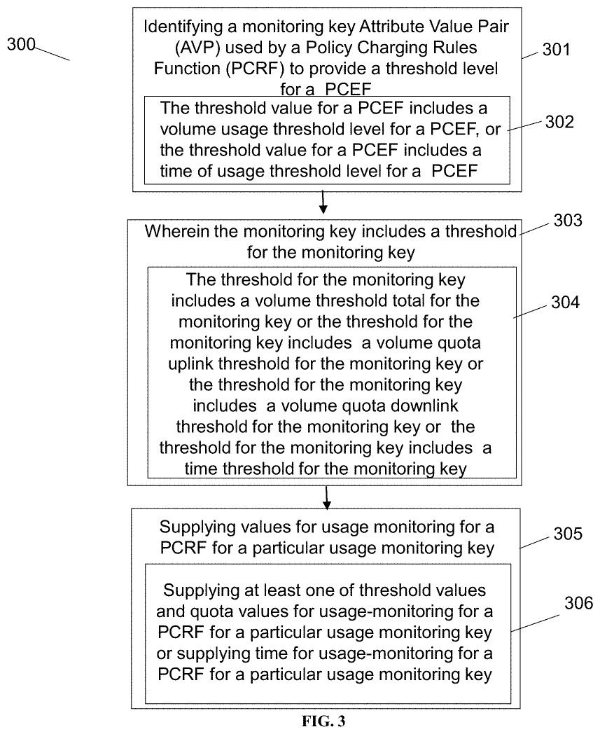

A flow chart of a particular embodiment of the presently disclosed method is depicted in FIG. 3. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language or hardware implementation. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 3, an example embodiment of a method 300 for performing usage-monitoring for a same monitoring key begins with processing block 301 which discloses identifying a monitoring key Attribute Value Pair (AVP) used by a Policy Charging Rules Function (PCRF) to provide a threshold level for a PCEF. As shown in processing block 302 the threshold value for a PCEF includes a volume usage threshold level for a PCEF or the threshold value for a PCEF includes a time of usage threshold level for a PCEF.

Processing block 303 recites wherein the monitoring key includes a threshold for the monitoring key. A disclosed in processing block 304 the threshold for the monitoring key includes a volume threshold total for the monitoring key, or the threshold for the monitoring key includes a volume quota uplink threshold for the monitoring key, or the threshold for the monitoring key includes a volume quota downlink threshold for the monitoring key, or the threshold for the monitoring key includes a time threshold for the monitoring key.

Processing block 305 states supplying values for usage monitoring for a PCRF for a particular usage monitoring key. Processing block 306 recites wherein supplying values for usage monitoring for a PCRF for a particular usage monitoring key includes supplying at least one of threshold values and quota values for usage-monitoring for a PCRF for a particular usage monitoring key, or wherein supplying values for usage monitoring for a PCRF for a particular usage monitoring key includes supplying time for usage-monitoring for a PCRF for a particular usage monitoring key.

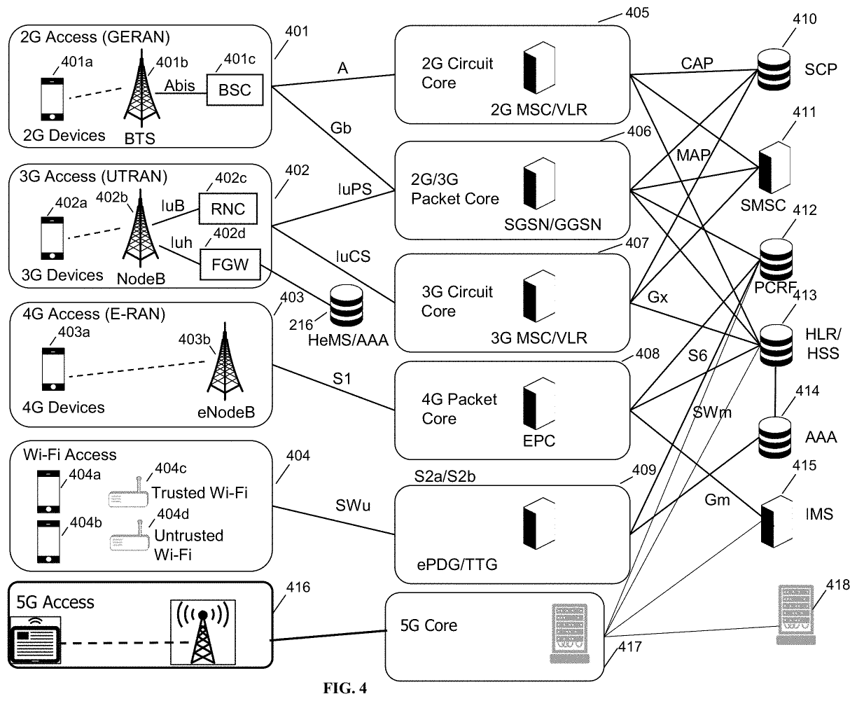

FIG. 4 is a schematic network architecture diagram 400 for 3G and other-G prior art networks. The diagram shows a plurality of “Gs,” including 2G, 3G, 4G, 5G and Wi-Fi. 2G is represented by GERAN 401, which includes a 2G device 401a, BTS 801b, and BSC 401c. 3G is represented by UTRAN 402, which includes a 3G UE 402a, nodeB 402b, RNC 402c, and femto gateway (FGW, which in 3GPP namespace is also known as a Home nodeB Gateway or HNBGW) 402d. 4G is represented by EUTRAN or E-RAN 403, which includes an LTE UE 403a and LTE eNodeB 403b. Wi-Fi is represented by Wi-Fi access network 404, which includes a trusted Wi-Fi access point 404c and an untrusted Wi-Fi access point 404d. The Wi-Fi devices 404a and 404b may access either AP 404c or 404d. In the current network architecture, each “G” has a core network. 4G circuit core network 405 includes a 4G MSC/VLR; 4G/3G packet core network 406 includes an SGSN/GGSN (for EDGE or UMTS packet traffic); 3G circuit core 407 includes a 3G MSC/VLR; 4G circuit core 408 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 430, the SMSC 431, PCRF 432, HLR/HSS 433, Authentication, Authorization, and Accounting server (AAA) 434, and IP Multimedia Subsystem (IMS) 435. An HeMS/AAA 436 is present in some cases for use by the 3G UTRAN. The diagram is used to indicate schematically the basic functions of each network as known to one of skill in the art, and is not intended to be exhaustive. For example, 5G core 417 is shown using a single interface to 5G access 416, although in some cases 5G access can be supported using dual connectivity or via a non-standalone deployment architecture.

Noteworthy is that the RANs 401, 402, 403, 404 and 436 rely on specialized core networks 405, 406, 407, 408, 409, 437 but share essential management databases 430, 431, 432, 433, 434, 435, 438. More specifically, for the 2G GERAN, a BSC 401c is required for Abis compatibility with BTS 401b, while for the 3G UTRAN, an RNC 402c is required for Iub compatibility and an FGW 402d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

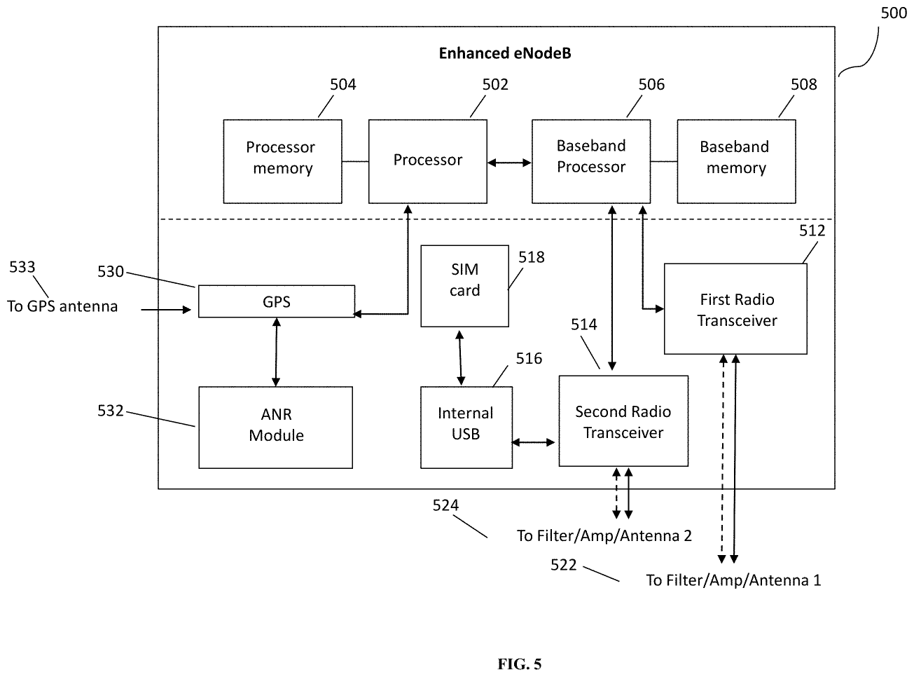

FIG. 5 is an enhanced eNodeB for performing the methods described herein, in accordance with some embodiments. Mesh network node 500 may include processor 502, processor memory 504 in communication with the processor, baseband processor 506, and baseband processor memory 508 in communication with the baseband processor. Mesh network node 500 may also include first radio transceiver 512 and second radio transceiver 514, internal universal serial bus (USB) port 516, and subscriber information module card (SIM card) 518 coupled to USB port 516. In some embodiments, the second radio transceiver 514 itself may be coupled to USB port 516, and communications from the baseband processor may be passed through USB port 516. The second radio transceiver may be used for wirelessly backhauling eNodeB 500.

Processor 502 and baseband processor 506 are in communication with one another. Processor 502 may perform routing functions, and may determine if/when a switch in network configuration is needed. Baseband processor 506 may generate and receive radio signals for both radio transceivers 512 and 514, based on instructions from processor 502. In some embodiments, processors 502 and 506 may be on the same physical logic board. In other embodiments, they may be on separate logic boards.

Processor 502 may identify the appropriate network configuration, and may perform routing of packets from one network interface to another accordingly. Processor 502 may use memory 504, in particular to store a routing table to be used for routing packets. Baseband processor 506 may perform operations to generate the radio frequency signals for transmission or retransmission by both transceivers 510 and 512. Baseband processor 506 may also perform operations to decode signals received by transceivers 512 and 514. Baseband processor 506 may use memory 508 to perform these tasks.

The first radio transceiver 512 may be a radio transceiver capable of providing LTE eNodeB functionality, and may be capable of higher power and multi-channel OFDMA. The second radio transceiver 514 may be a radio transceiver capable of providing LTE UE functionality. Both transceivers 512 and 514 may be capable of receiving and transmitting on one or more LTE bands. In some embodiments, either or both of transceivers 512 and 514 may be capable of providing both LTE eNodeB and LTE UE functionality. Transceiver 512 may be coupled to processor 502 via a Peripheral Component Interconnect-Express (PCI-E) bus, and/or via a daughtercard. As transceiver 514 is for providing LTE UE functionality, in effect emulating a user equipment, it may be connected via the same or different PCI-E bus, or by a USB bus, and may also be coupled to SIM card 518. First transceiver 512 may be coupled to first radio frequency (RF) chain (filter, amplifier, antenna) 522, and second transceiver 514 may be coupled to second RF chain (filter, amplifier, antenna) 524.

SIM card 518 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 500 is not an ordinary UE but instead is a special UE for providing backhaul to device 500.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 512 and 514, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 502 for reconfiguration.

A GPS module 530 may also be included, and may be in communication with a GPS antenna 532 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 532 may also be present and may run on processor 502 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

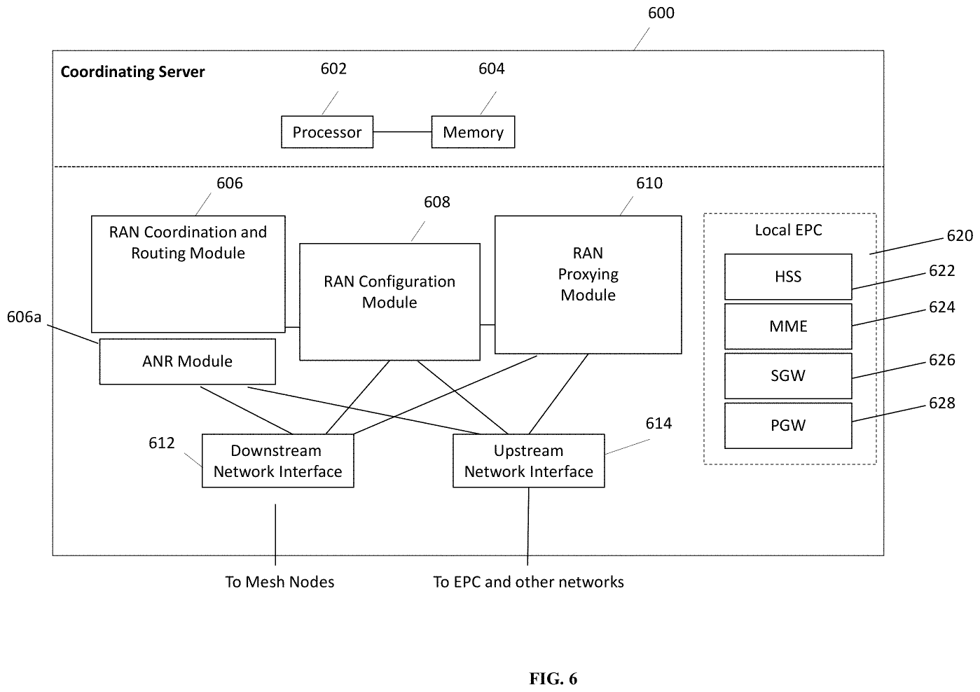

FIG. 6 is a coordinating server for providing services and performing methods as described herein, in accordance with some embodiments. Coordinating server 600 includes processor 602 and memory 604, which are configured to provide the functions described herein. Also present are radio access network coordination/routing (RAN Coordination and routing) module 606, including ANR module 606a, RAN configuration module 608, and RAN proxying module 610. The ANR module 606a may perform the ANR tracking, PCI disambiguation, ECGI requesting, and GPS coalescing and tracking as described herein, in coordination with RAN coordination module 606 (e.g., for requesting ECGIs, etc.). In some embodiments, coordinating server 600 may coordinate multiple RANs using coordination module 606. In some embodiments, coordination server may also provide proxying, routing virtualization and RAN virtualization, via modules 610 and 608. In some embodiments, a downstream network interface 612 is provided for interfacing with the RANs, which may be a radio interface (e.g., LTE), and an upstream network interface 614 is provided for interfacing with the core network, which may be either a radio interface (e.g., LTE) or a wired interface (e.g., Ethernet).

Coordinator 600 includes local evolved packet core (EPC) module 620, for authenticating users, storing and caching priority profile information, and performing other EPC-dependent functions when no backhaul link is available. Local EPC 620 may include local HSS 622, local MME 624, local SGW 626, and local PGW 628, as well as other modules. Local EPC 620 may incorporate these modules as software modules, processes, or containers. Local EPC 620 may alternatively incorporate these modules as a small number of monolithic software processes. Modules 606, 608, 610 and local EPC 620 may each run on processor 602 or on another processor, or may be located within another device.

In 5GC, the function of the SGW is performed by the SMF and the function of the PGW is performed by the UPF. The inventors have contemplated the use of the disclosed invention in 5GC as well as 5G/NSA and 6G. As applied to 5G/NSA, certain embodiments of the present disclosure operate substantially the same as the embodiments described herein for 6G. As applied to 5GC, certain embodiments of the present disclosure operate substantially the same as the embodiments described herein for 6G, except by providing an N4 communication protocol between the SMF and UPF to provide the functions disclosed herein.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof.

The word “cell” is used herein to denote either the coverage area of any base station, or the base station itself, as appropriate and as would be understood by one having skill in the art. For purposes of the present disclosure, while actual PCIs and ECGIs have values that reflect the public land mobile networks (PLMNs) that the base stations are part of, the values are illustrative and do not reflect any PLMNs nor the actual structure of PCI and ECGI values.

In the above disclosure, it is noted that the terms PCI conflict, PCI confusion, and PCI ambiguity are used to refer to the same or similar concepts and situations, and should be understood to refer to substantially the same situation, in some embodiments. In the above disclosure, it is noted that PCI confusion detection refers to a concept separate from PCI disambiguation, and should be read separately in relation to some embodiments. Power level, as referred to above, may refer to RSSI, RSFP, or any other signal strength indication or parameter.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method for performing usage-monitoring for a same monitoring key, comprising:
identifying a monitoring key Attribute Value Pair (AVP) used by a Policy Charging Rules Function (PCRF) to provide a threshold level for a PCEF;
wherein the monitoring key includes a threshold for the monitoring key; and
supplying values for usage monitoring for a PCRF for a particular usage monitoring key.

2. The method of claim 1 wherein the threshold value for a PCEF includes a volume usage threshold level for a PCEF.

3. The method of claim 1 wherein the threshold value for a PCEF includes a time of usage threshold level for a PCEF.

4. The method of claim 1 wherein the threshold for the monitoring key includes a volume threshold total for the monitoring key.

5. The method of claim 1 wherein the threshold for the monitoring key includes a volume quota uplink threshold for the monitoring key.

6. The method of claim 1 wherein the threshold for the monitoring key includes a volume quota downlink threshold for the monitoring key.

7. The method of claim 1 wherein the threshold for the monitoring key includes a time threshold for the monitoring key.

8. The method of claim 1 wherein supplying values for usage monitoring for a PCRF for a particular usage monitoring key includes supplying at least one of threshold values and quota values for usage-monitoring for a PCRF for a particular usage monitoring key.

9. The method of claim 1 wherein supplying values for usage monitoring for a PCRF for a particular usage monitoring key includes supplying time for usage-monitoring for a PCRF for a particular usage monitoring key.

10. A non-transitory computer-readable medium containing instructions for performing usage-monitoring for a same monitoring key, which, when executed, cause a system to perform steps comprising:
identifying a monitoring key Attribute Value Pair (AVP) used by a Policy Charging Rules Function (PCRF) to provide a threshold level for a PCEF;
wherein the monitoring key includes a threshold for the monitoring key; and
supplying values for usage monitoring for a PCRF for a particular usage monitoring key.

11. The computer-readable medium of claim 10 including instructions wherein the threshold value for a PCEF includes a volume usage threshold level for a PCEF.

12. The computer-readable medium of claim 10 including instructions wherein the threshold value for a PCEF includes a time of usage threshold level for a PCEF.

13. The computer-readable medium of claim 10 including instructions wherein the threshold for the monitoring key includes a volume threshold total for the monitoring key.

14. The computer-readable medium of claim 10 including instructions wherein the threshold for the monitoring key includes a volume quota uplink threshold for the monitoring key.

15. The computer-readable medium of claim 10 including instructions herein the threshold for the monitoring key includes a volume quota downlink threshold for the monitoring key.

16. The computer-readable medium of claim 10 including instructions wherein the threshold for the monitoring key includes a time threshold for the monitoring key.

17. The computer-readable medium of claim 10 wherein the instructions for supplying values for usage monitoring for a PCRF for a particular usage monitoring key include instructions for supplying at least one of threshold values and quota values for usage-monitoring for a PCRF for a particular usage monitoring key.

18. The computer-readable medium of claim 10 wherein the instructions supplying values for usage monitoring for a PCRF for a particular usage monitoring key include instructions for supplying time for usage-monitoring for a PCRF for a particular usage monitoring key.
